(19) United States
(12) Patent Application Publication
(10) Pub. No.: US 2011/0132164 A1
(43) Pub. Date: Jun. 9, 2011

(54) PUNCHING MACHINE WITH COMPACT FRAME

(76) Inventor: Juan Ignacio Barandiaran Echeguia, Guipuzcoa (ES)

(21) Appl. No.: 12/997,060

(22) PCT Filed: Jun. 2, 2009
(86) PCT No.: PCT/ES2009/070195

§ 371 Date: Feb. 16, 2011

(30) Foreign Application Priority Data
Jun. 12, 2008 (ES) P200801774

(51) Int. Cl. B26D 5/12; B26D 7/01; B26D 7/26

(52) U.S. Cl. 83/145; 83/639.5; 83/698.91

(57) ABSTRACT

The invention provides the possibility of incorporating various fixed punching stations within a single compact frame, being applicable especially to the punching of holes in the flanges of angular profiles. The punching cylinders to which the punches and punch-holders are fastened, as well as the dies and the die-holders fastened to the compact frame, allow the punching of holes at the different radial distances required in the flanges of said angular profiles. It is possible since the punch-holders and die-holders have varying eccentricities in their respective seats for the punches and dies. It is possible to select pairs of punches and dies having same eccentricity. The punch-holders and the die-holders are equipped with means for angular positioning in the respective cylinder and the compact frame.

### OBJECT OF THE INVENTION

The present invention, as this specification states in its title, relates to a punching machine with compact frame. With this punching machine with compact frame holes aligned in the flanges of angular profiles are obtained, as well as the cutting of the angular profiles at the required lengths.

It is an object of the invention to mount in a compact frame the punching stations known from the state of the art and the punching station adopting thereof a fixed position so as to obtain an advantage of decreasing the size of the machine.

### BACKGROUND OF THE INVENTION

Currently an automatic line for punching and cutting angular profiles has on one side a feeding system and on the other side the corresponding punching stations. It also includes a device for cutting the already punched profiles.

Punching stations consist of:
A punching cylinder which provides the force required for punching.
The punch-holder, which is the element that receives the force of the punching cylinder and which is coupled to said cylinder rod.
The punch, which is the tool coupled in the punch-holder. The active end shape of said punch will be the negative of the hole desired to be obtained in the piece to punch and will also correspond with the hole carrying the die.
The die-holder, as the element wherein the die will be placed.
The die, which defines the complementary tool of the punch.
A stripper element, which holds the piece to be punched during the punching operation.

All these elements constituting each punching station are coupled into the frame of the punching machine.

Currently, if it is desired to have several punching stations in a single punching machine, there are two alternatives:
The first one of them consists of providing a frame for each punching station. Thus the machine size considerably increases since each punching station it is has to be a frame where the corresponding punches and dies can be mounted in different positions.
The second alternative would be the use of a fixed frame on which movable punching stations will be placed, such that if the punching position is desired to be varied, the arrangement of the punching stations in said frame would have to be modified. This alternative involves the use of a large size frame so as to allow varying the positions of its punching stations and the actuation of the machine has to be carried out in two perpendicular directions corresponding to the flanges of the angular profile to be punched.

### DESCRIPTION OF THE INVENTION

In general terms, the punching machine with compact frame object of the invention consists of a sturdy compact frame wherein the punching cylinders are fixed so they can not change their relative position in the compact frame. Therefore, the punch-holders and punches, as well as and the die-holders and dies do not change position.

As the punching cylinders have a fixed position, these punching cylinders can be arranged very close to each other and the stripper element of the angular profile that has to act during the punching stage can have a fixed location in the mentioned frame and be between the two punching cylinders acting in two perpendicular directions although longitudinally shifted from the profile.

The profile to be punched is located in a feeding station prior to the machine. This feeding station consists of a series of, rollers arranged in a “V” shape, such that the flanges of the angular profile to be punched are placed on said rollers. The rollers provide the profile with a linear forward movement towards the feeding unit of the machine. Said feeding unit of the machine has two wheels, a driving wheel and a stripper wheel, vertically aligned such that the profile is placed between both wheels. These wheels will move the profile forward in the machine by steps defined by the numerical control of the machine.

In order to drill the drill-holes in the flanges of the angular profile in different transverse positions, depending on the dimensions of said angular profile, as well as on the distance to the edge corresponding to the vertex of the “L”-shaped section of equal or different flanges, when the position of the punching cylinders can not be varied, the position is varied with the use of eccentric punch-holders and die-holders. The eccentricity of the punch-holders and of the die-holders will define the transverse position of the holes formed in the punching operation. Furthermore, if the holes have a shape different from the circular one, it will be enough to use punches and dies having the shape wanted for the holes.

Thus there will be pairs of punch-holders and die-holders according a range of eccentricities, thus only being necessary to replace the punch-holder and the die-holder consistent with the eccentric position of the hole to be formed relative to the corresponding edge of the angular profile. Once this is determined, it is only necessary to select the punch and the punch-holder corresponding to the shape and sizes of the hole to be punched.

The removal of punches and dies from the punch-holder and die-holder, respectively, is performed without changing their position in the compact frame.

The punch-holder which is anchored in the rod of the corresponding actuation hydraulic cylinder is mounted at an angular position determined by a diametral rib at the base of the punch-holder and a receiver key-groove located at the base of the cylinder rod. The anchoring is carried out by a bar coaxial to the cylinder and fixed to the punch-holder. The outer threaded end of the bar has a lock nut.

Likewise, the die-holder has to adopt a fixed position in the compact frame. The fixed position of the die-holder is achieved by having the die-holder a cylindrical outline but with two faceted or milled faces and by having the frame a seat with the same section.

The punch is fixed to the punch-holder by using a screw passing through the wall of the punch-holder in an oblique position but perpendicular to an existing bevelled milling on the end of said punch-holder. The active end of the screw sets on a notch provided in correspondence with the cylindrical wall of the punch.

On the other hand, to avoid the leaving of the die-holder form its seat, the axial fitting of the die-holder into the frame is defined by a screw mounted in a radial hole of the frame. The active end of the screw directly sets on the die-holder wall. Instead of performing this clamping by said screw in a radial position, a perfect locking of die-holder is also achieved by using a sliding wedge in a frame seat, which sets on a faceted face of the die-holder.

When the punches are not cylindrical but have a section different from this one it in their active end, which also coincides with the one presented by the calibrated hole of the die, the position of the punch has to be angularly fixed. To fix angularly the position of the punch, the punch-holder includes a radial key-groove wherein a key built into the punch is sat. The angular positioning of the die with respect to the die-holder is performed by using a radial screw threaded into the wall of the die-holder and the active end of said radial screw matches with an axial slot on the die periphery.

In order to facilitate the understanding of the characteristics of the invention and being an integral part of this specification, sheets of figures are attached on which, with an illustrative and not limitative manner, the following has been represented:

### BRIEF DESCRIPTION OF THE DRAWINGS

FIG. 1. —It is a perspective view of the punching machine with compact frame, object of the invention.

FIG. 2. —It is an elevational partial view of the same punching machine, wherein the punching zone is shown.

FIG. 3. —It is a perspective partial view of the zone wherein the punches and dies are.

FIG. 4. —It is an elevational partial view, showing the stage of changing the punches.

FIG. 5. —It is a view similar to the one of FIG. 4 but shows the stage of changing the dies.

FIGS. 6 and 7. —These are respective perspective views of a set of punch-holder and die-holder, with a very pronounced eccentricity for coupling the punch and die, respectively.

FIGS. 8 and 9. —These are views similar to that of FIGS. 6 and 7, of another set of punch-holder and die-holder, with less eccentricity of the seat in the respective punch and die.

FIG. 10. —It is a view similar to that of FIG. 5 wherein the stage of removing the die-holder is indicated.

FIG. 11. —It is a perspective view similar to that of FIG. 3 but shows the stage of changing one of the die-holders.

FIG. 12. —It is a view similar to that of FIG. 3, with punches and dies with an extended shape to drill extended drill-holes.

### DESCRIPTION OF THE PREFERRED EMBODIMENT

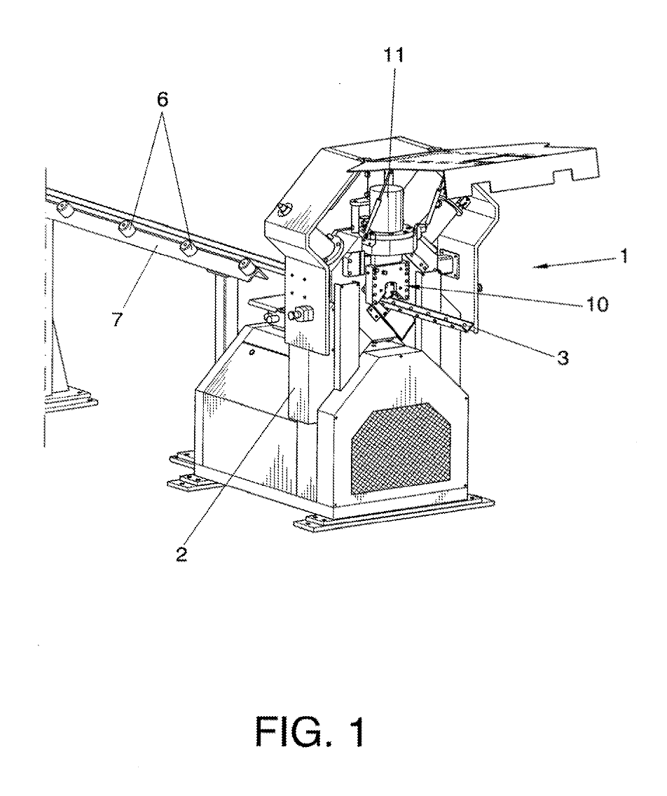

Referring to the numbering adopted in the figures and particularly in relation to FIG. 1, it is shown a punching machine 1 with a compact frame 2 wherein, according to the invention, several punching stations (namely two) which occupy fixed positions in the same frame 2 are integrated. The frame 2 is has also a fixed position. Thus there is no need to change basic and heavy machine elements for performing different drill-hole distribution in the angular profiles 3, being only required to change the punch-holders 4 and die-holders 5 as will be explained later since it is not shown in this FIG. 1.

This type of punching machines includes means for supporting and directing the angular profiles 3 to be punched which are known. Also the rollers 6 are known. Those rollers 6 are mounted on a profile 7 and by means of the rollers the profile can move exactly aligned with the compact frame 2 seat. The rollers support the profile flanges to be punched on the respective die 8 for drilling the holes in both flanges when the respective punches 9 act. The distance between the holes in a single flange is obtained by previously setting the forward motion of the angular profile 3, which usually takes place through the machine numerical control.

This type of punching machines also has a cutting device 10 which is a blade that goes down by actuating a hydraulic cylinder 11, cutting the angular profile 3 at the desired length at the machine outlet.

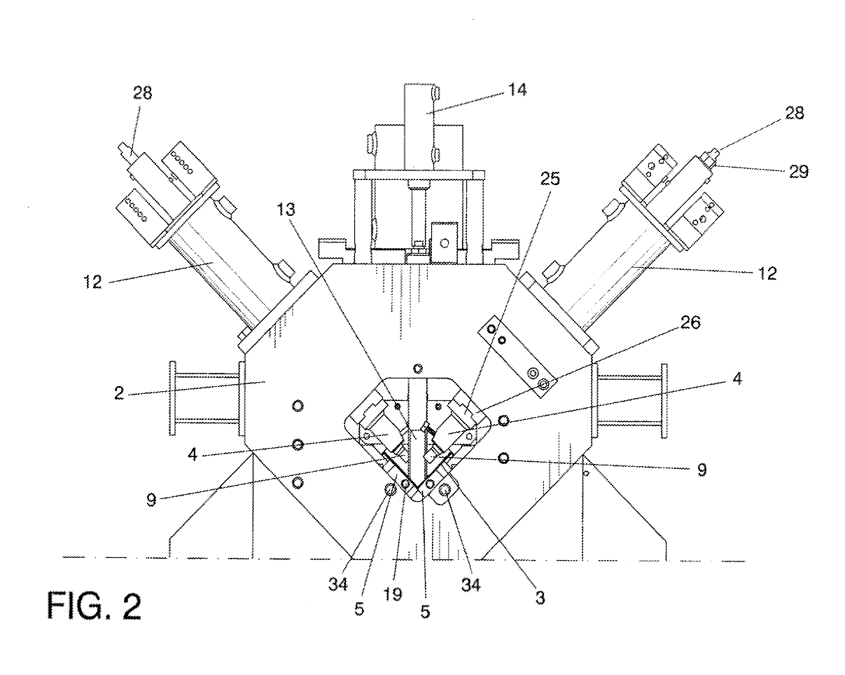

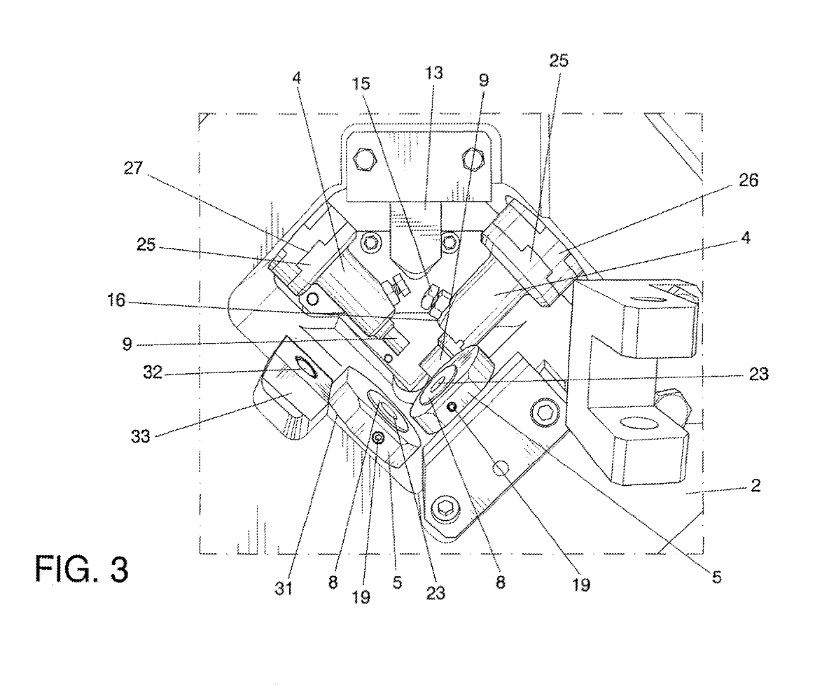

In FIGS. 2 and 3 the punches 9 and dies 8 are shown in correspondence, coupled to their respective punch-holders 4 and die-holders 5.

The punches 9 are actuated by respective hydraulic cylinders 12 and before punching, the angular profile 3 is immobilized by a stripper plate 13 movable by a hydraulic cylinder 14. This stripper plate 13 occupies an intermediate position between the vertical actuation planes of the punches 9 since these are shifted so as not interfere with each other.

In FIG. 2, the stripper plate 13 is acting on the angular profile 3. In FIG. 3 is raised since the angular profile 3 to be punched is not included.

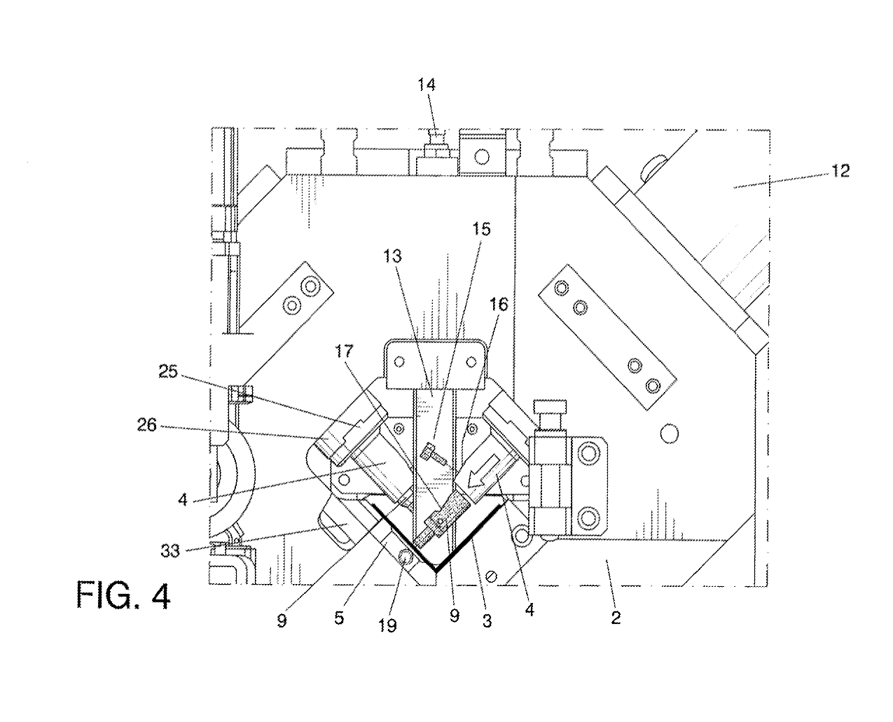

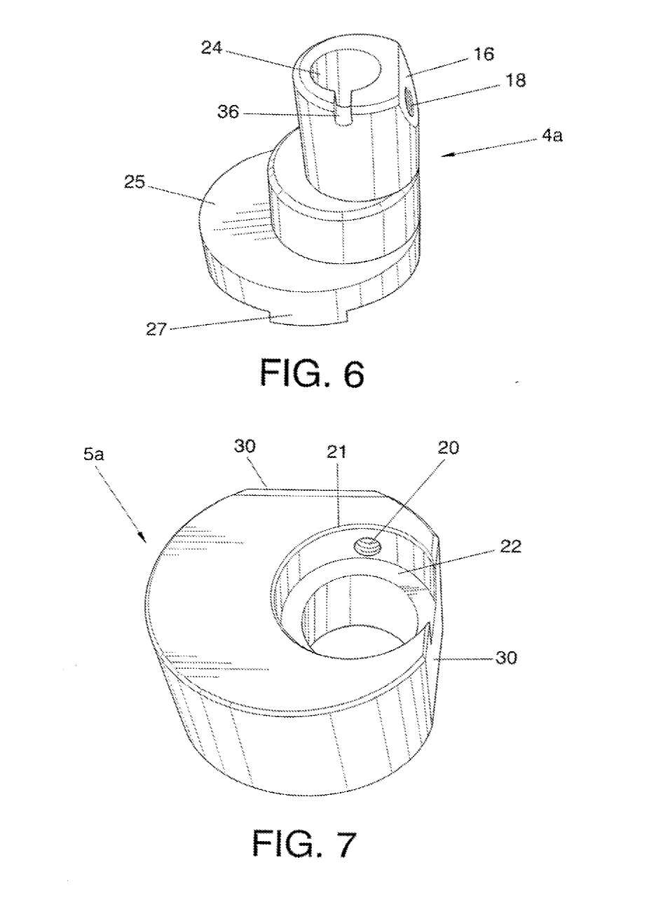

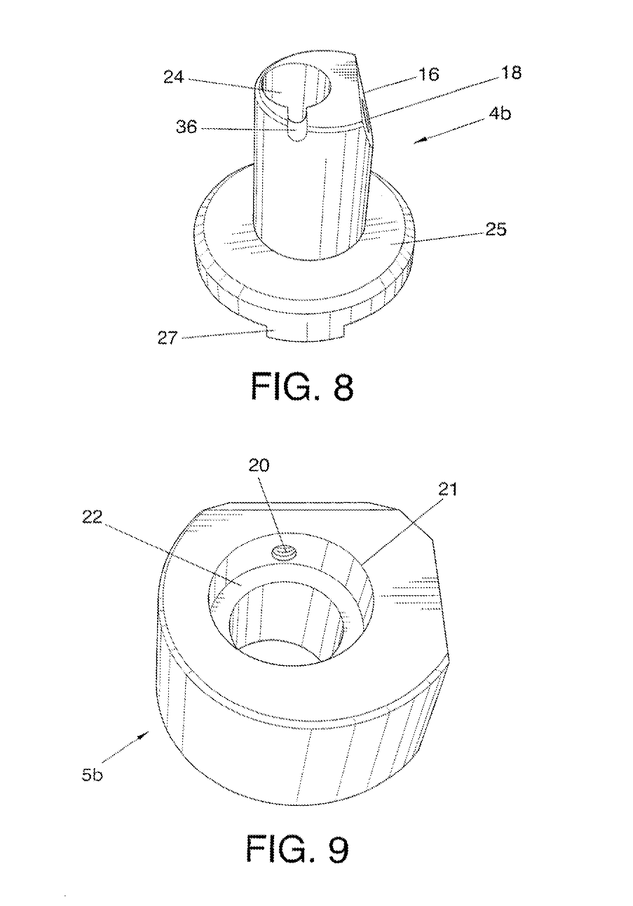

In FIG. 4 the punch 9 is shown in a demounted position from the punch-holder 4 when a change of punch is required, either because it has been damaged or worn or for exchanging it by another with a different section. For this purpose, the screw 15 threaded into the punch-holder 4 (see FIG. 3) in a tilted position with respect to the geometric axis, in perpendicular direction to the milled or bevelled end 16, is loosened or removed. The active end of the screw 15 thus comes out from the notch 17 provided for this purpose in the punch 9 body. The screw 15 passes through the threaded hole 18 provided in said bevelled end 16 (see FIGS. 6 and 8).

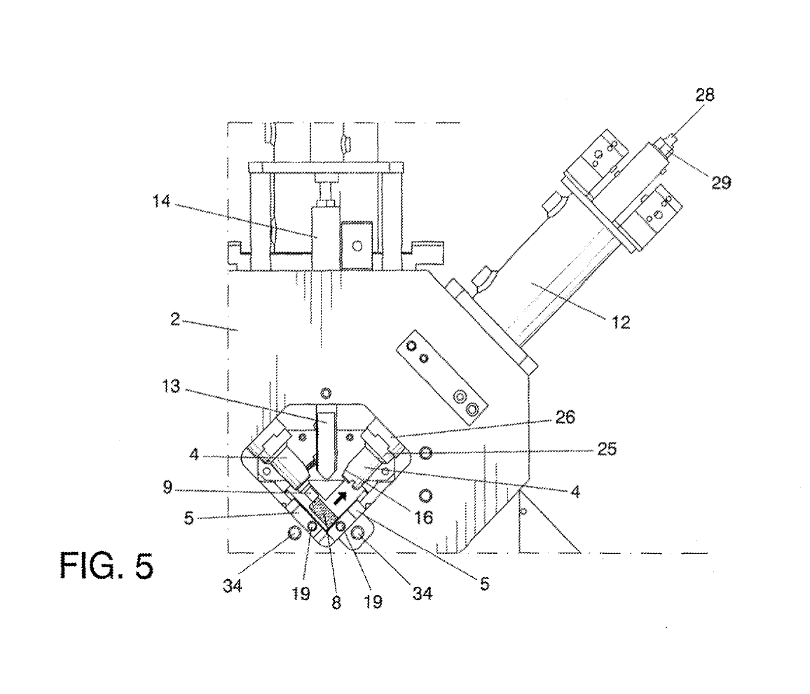

In FIG. 5 the change of a die 8 mounted into the die-holder 5 has been represented. For this purpose the screw 19 fitted into the threaded hole 20 (see FIGS. 7 and 9) of the die-holder 5 is loosened, the die 8 easily coming out from its receiver seat 21. The die 8 rests on the annular surface of the seat 22 which is concentric with the calibrated hole 23 of the die (see FIG. 3) adjusted to the diameter of the active end of the punch 9.

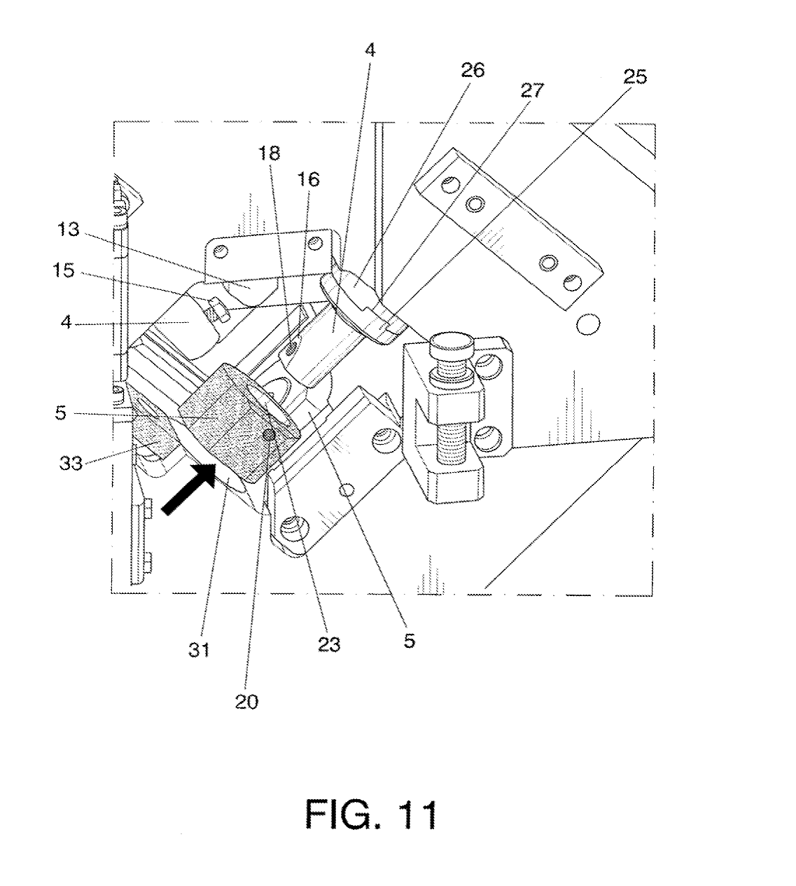

In FIGS. 6 and 7 it can be seen a set of punch-holder 4a and die-holder 5a with a very pronounced eccentricity in the receiver seat 24 of the punch 9, with respect to the geometrical axis of the cylindrical base 25 thereof. The cylindrical base is provided at its bottom in its end connecting to the rod 16 of the cylinder 12 with the diametral key 27 that fits into the key-groove of the hydraulic cylinder for the correct angular positioning of the punch. The axial fixing is performed through a bar 28 axially running throughout the cylinder 12 and which is anchored to the base 25 of the punch-holder 4 or 4a, protruding towards the cylinder 12 outside and offering a threaded portion for locating a tightening end nut 29. Regarding the die-holder 5 or 5a, this is located on its position by using the millings 30 in its cylindrical surface defining an outline adjusted to the corresponding section of the respective seat 31, made in the compact frame 2. The fixing is obtained according to FIGS. 3 and 4 by using a screw 32 for tightening the wedge 33 sliding along a frame seat, and setting on a faceted face of the die-holder 5a. FIG. 11 shows how to perform the removal of the die-holders 5 once the tightening screw 32 is loosened.

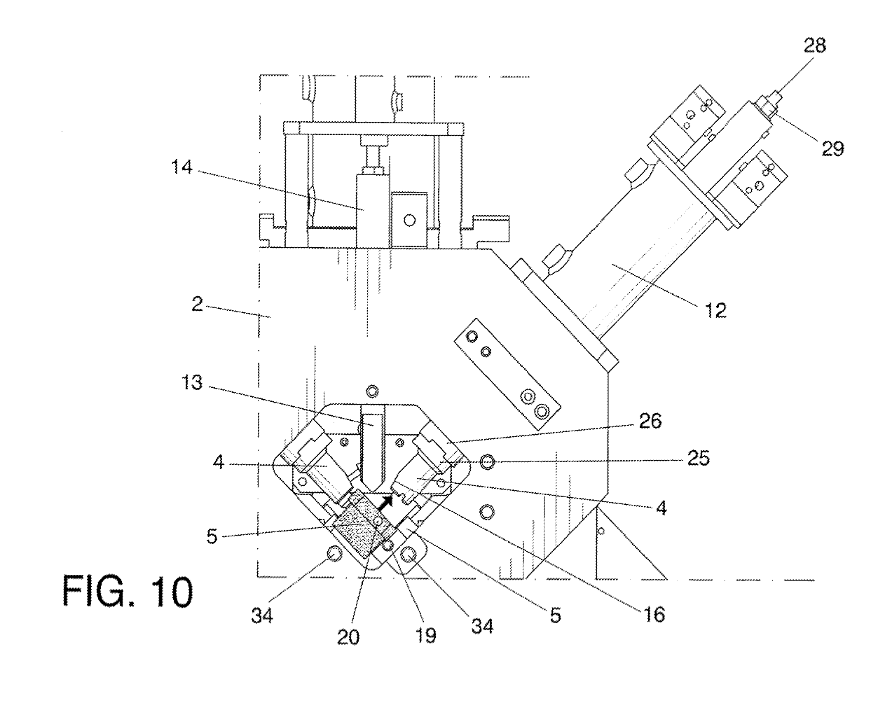

Clamping the die-holders 5 (see FIGS. 2, 5 and 10) is preformed only by using the respective screws 34 on the sides of the compact frame 2. For removing the die-holder 5 (see FIG. 10) the screw 34 is loosened, and thus the die-holder comes out easily.

FIGS. 8 and 9 show another set of punch-holder 4b and corresponding die-holder 5b having less eccentricity but fixed in the same way in their respective seats.

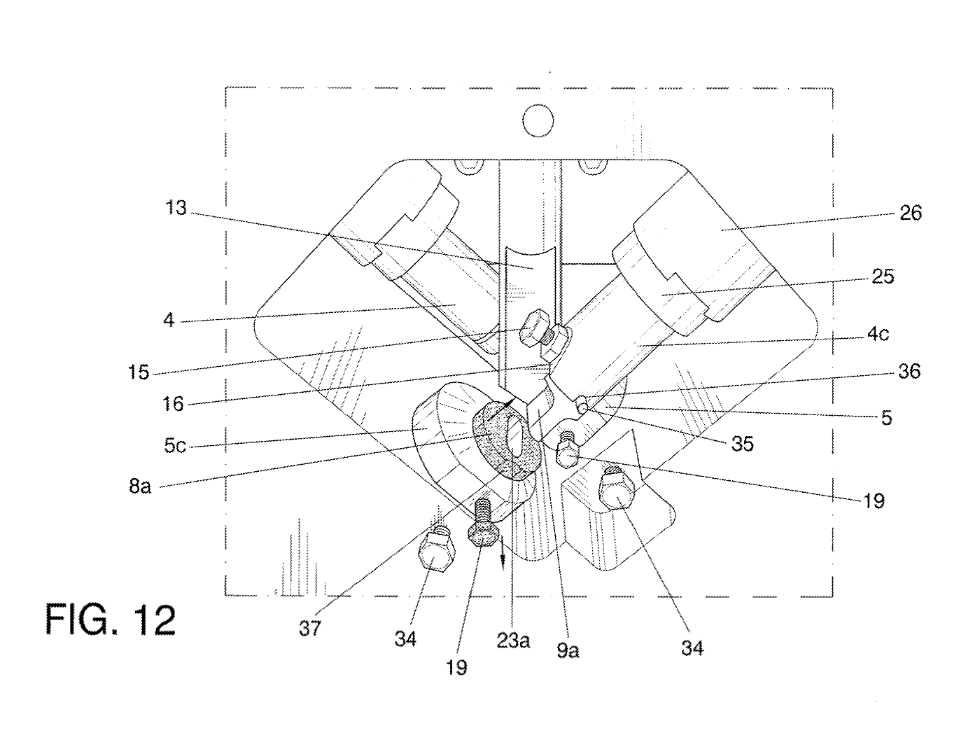

Regarding FIG. 12, the punch 9a in its active end has a non-circular geometric shape, for drilling extended holes in the flanges of the angular profile 3. The die 8a has a corresponding section in its calibrated hole 23a. For fixing the mounting positions of both elements, the punch 9a has a radial key 35 sat into the radial key-groove 36 of the punch-holder 4c. When punches 9 are circular, the key 35 is not needed even though a key-groove 36 exits.

The same occurs with the die 8a whose extended calibrated hole 23a must have a certain direction and coincide with the punch 9a. For this purpose the tightening screw 19 carrying the die-holder 5c has to be aligned with a radial slot 37 that in this case carries the die 8a.

1-8. (canceled)

9. Punching machine with compact frame, where several punching stations are integrated, and particularly for angular profiles, wherein the punching stations occupy fixed positions within the same compact frame, and a cutting station occupying a fixed position within the mentioned compact frame is also integrated, having punching cylinders occupying fixed positions in said compact frame and which are fastened to punch-holders such that the punch-holders also occupy fixed positions, as well as die-holders fastened to the compact frame, the die-holders also occupying fixed positions, existing a stripper element for holding the angular profile during the punching stage occupying a fixed position within the compact frame, being located said stripper element between the punching cylinders, with the punch-holders being fastened to punches and die-holders being fastened to dies having their respective seats for the punches and dies in different eccentric positions and distributed in sets of couples with the same eccentricity, the facing positions of both punch-holder and die-holder elements being fixed at the required distances and shapes arranged transversally to the angular profile when selecting the desired couple, and the punch-holder being holder of the means for angular positioning in the respective hydraulic cylinder, and the die-holder being holder of the means for angular positioning in the compact frame.

10. Punching machine with compact frame, according to claim 9, wherein the means for angular positioning the punch-holder in the cylinder are determined by a diametral rib at the base of the punch-holder and a receiver key-groove located at the base for anchoring the hydraulic cylinder, being axially fixed with a bar coaxial to the cylinder and fixed to the punch-holder, and which is locked with an outside nut.

11. Punching machine with compact frame, according to claim 9, wherein the means for angular positioning the die-holder in the compact frame are determined by the cylindrical outline with two faceted or milled faces of the die-holder.

12. Punching machine with compact frame, according to claim 11, wherein there are means for axial fixing the die-holder to the compact frame, determined by a screw threaded into the side of the latter, and the active end of the screw sets on the die-holder wall.

13. Punching machine with compact frame, according to claim 11, wherein there are means for axial fixing the die-holder to the compact frame, determined by a wedge sliding along a seat of the compact frame, and setting on a faceted face of the die-holder.

14. Punching machine with compact frame, according to claim 9, wherein the punch-holder includes at its end a radial key-groove wherein a key, provided in the punches with a shape other than the cylindrical one, is sat, and the punch is fixed to the punch-holder by using a screw threaded to it in a position oblique and perpendicular to a bevelled milling of its end, which sets on a notch being in correspondence with the punch wall.

15. Punching machine with compact frame, according to claim 9, wherein the die is fixed to the die-holder by using a radial screw threaded to it, and end of which matches with an axial slot in the die periphery if this has to adopt a certain position from a punch with a section other than the cylindrical one.
